(19) United States
(12) Patent Application Publication
(10) Pub. No.: US 2022/0094555 A1
(43) Pub. Date: Mar. 24, 2022

(54) VALIDATOR CONTROL FOR TRANSACTION BETWEEN BLOCKCHAINS

(71) Applicant: FUJITSU LIMITED, Kawasaki-shi (JP)

(72) Inventors: Arnab ROY, Santa Clara, CA (US); Hart MONTGOMERY, Redwood City, CA (US); Avradip MANDAL, San Jose, CA (US)

(73) Assignee: FUJITSU LIMITED, Kawsaki-shi (JP)

(21) Appl. No.: 17/024,933

(22) Filed: Sep. 18, 2020

(51) Int. Cl. H04L 9/32; H04L 9/08; G06Q 20/40

(52) U.S. Cl. CPC H04L 9/3255; H04L 9/0825; H04L 9/085; G06Q 2220/00; H04L 2209/38; H04L 2209/46; G06Q 20/401

(57) ABSTRACT

A validation system includes a plurality of validator devices. Each of the plurality of validator devices is assigned with a group signature. The validation system receives a cross-blockchain transaction from a plurality of transaction participant devices. The cross-blockchain transaction is associated with a plurality of blockchains. The validation system further controls a first validator device of the plurality of validator devices to apply an extended smart contract on the received cross-blockchain transaction. Further, the validation system validates the application of the extended smart contract on the cross-blockchain transaction based on the group signature assigned to each of the plurality of validator devices, to generate a transaction validation result. Further, the validation system transmits the generated transaction validation result, associated with the validation of the cross-blockchain transaction, to the plurality of blockchains. The transaction validation result is signed with the assigned group signature.

### FIELD

The embodiments discussed in the present disclosure are related to systems and methods for validator control for transactions between multiple blockchains.

### BACKGROUND

Recent advancements in the field of blockchain have led to development of various techniques related to cross-blockchain transactions. Such techniques enable the flow of the transactions between multiple blockchains but does not necessarily guarantee authenticity of the transactions. In certain situations, an external validator may be required for validating transactions across the multiple blockchains. However, certain conventional external validators may be biased and may not be reliable enough to provide validations to the cross-blockchain transactions. Hence, integrity of the flow of the cross-blockchain transactions may be difficult to maintain. In light of the abovementioned problems, an advanced system may be required which may provide unbiased and reliable validated cross-blockchain transactions that may ensure integrity of the cross-blockchain transactions.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a validation system may be provided. The validation system may comprise a plurality of validator devices. Each of the plurality of validator devices is assigned with a group signature. The validation system may further comprise a processor. The processor may be configured to receive a cross-blockchain transaction from a plurality of transaction participant devices. The cross-blockchain transaction may be associated with a plurality of blockchains. Moreover, the processor may be configured to control a first validator device of the plurality of validator devices to apply an extended smart contract on the received cross-blockchain transaction associated with the plurality of blockchains. The processor may be further configured to validate the application of the extended smart contract on the cross-blockchain transaction based on the group signature assigned to each of the plurality of validator devices, to generate a transaction validation result. Moreover, the processor may be further configured to transmit the generated transaction validation result, associated with the validation of the cross-blockchain transaction, to the plurality of blockchains. The transaction validation result may be signed with the assigned group signature.

According to an aspect of another embodiment, a method may be provided. The method may be executed in a validation system comprising a plurality of validator devices. Each of the plurality of validator devices is assigned with a group signature. The method may comprise receiving a cross-blockchain transaction from a plurality of transaction participant devices. The cross-blockchain transaction is associated with a plurality of blockchains. The method may further comprise controlling a first validator device of the plurality of validator devices to apply an extended smart contract on the received cross-blockchain transaction associated with the plurality of blockchains. Moreover, the method may comprise validating the application of the extended smart contract on the cross-blockchain transaction based on the group signature assigned to each of the plurality of validator devices, to generate a transaction validation result. The method may further comprise transmitting the generated transaction validation result, associated with the validation of the cross-blockchain transaction, plurality of blockchains. The transaction validation result may be signed with the assigned group signature.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example environment related to validation of cross-blockchain transactions;

FIG. 2 is a block diagram that illustrates an exemplary validation system for the validation of the cross-blockchain transactions;

FIGS. 3A-3C collectively illustrate an exemplary sequence diagram depicting the validation of the cross-blockchain transactions by the validation system of FIG. 1;

FIG. 4 illustrates a flowchart of an example method related to audit performed by the validation system of FIG. 1;

FIG. 5 illustrates a flowchart of an example method related to validation of cross-blockchain transactions by the validation system of FIG. 1;

all according to at least one embodiment described in the present disclosure.

### DESCRIPTION OF EMBODIMENTS

Some embodiments described in the present disclosure relate to validation system and a method for validation of cross-blockchain transactions, such as via a plurality of validator devices. A validation system in the present disclosure may provide validation to the cross-blockchain transactions that may take place across multiple blockchains (such as a plurality of blockchains). The validation system may utilize a validator device (such as a first validator device) of a plurality of validator devices to validate the cross-blockchain transaction. Moreover, for a purpose of maintaining privacy of the first validator device, each of the plurality of validator devices may be assigned with a group signature. The validation system may generate a transaction validation result associated with validation of the cross-blockchain transaction, such as the transaction validation result may be signed with the group signature and further transmitted to the plurality of blockchains. Thus, the transaction validation result signed with the group signature provides assurance to a plurality of transaction participants associated with the plurality of blockchains, that the cross-blockchain transaction has been verified by a trusted validator device (for example, the first validator device) that may be registered with the validation system. It may be noted that, as the transaction validation result may be signed with the group signature (i.e. that may be common to all the plurality of validator devices), an identity of the trusted validator device (such as the first validator device) may be unknown to the plurality of transaction participants associated with the plurality of blockchains. Moreover, as the identity of the first validator device may be unknown to the plurality of transaction participants, the first validator device may not be biased or bribed by any of the plurality of transaction participants to attain false verification of the cross-blockchain transaction in favor of itself. Thus, the privacy of the first validator device may be maintained while ensuring authentic verification of the cross-blockchain transaction. Therefore, the validation system in the present disclosure provides unbiased and reliable validation of the cross-blockchain transaction that may ensure integrity of the cross-blockchain transaction.

According to one or more embodiments of the present disclosure, the validation system may further perform an audit to verify integrity of the plurality of validator devices, for example the first validator device in the validation of the cross-blockchain transaction. A request for the audit may be received either from one of the plurality of validator devices or from a first transaction participant device of the plurality of transaction participant devices. In some embodiments, the audit may be performed at a regular basis to ensure that each of the plurality of validators registered in the validator system are authentic.

In one or more embodiments, the validator system may further deanonymize the first validator device of the plurality of validator devices, based on a failure of the audit performed by the validation system. The validation system may generate the identity information of such first validator device, and further transmit the identity information of the deanonymized first validator to the plurality of transaction participants and the plurality of validator devices, thereby, informing the plurality of transaction participant devices and the plurality of validator devices about a defaulter validator device (for example, the first validator device if the first validator device fails the audit).

In accordance with an embodiment, the validation system may further remove the first validator device from the plurality of validator devices based on the failure of the audit. The validation system may remove the first validator device based on failure of the verification of the integrity of the first validator device for the validation performed on the cross-blockchain transaction. Furthermore, the validation system may re-configure or re-setup the validation system with other validator devices of the plurality of validator devices. The other validator devices may be different from the first validator device that may be removed from the plurality of validator devices. Thus, the disclosed validation system in the present disclosure may provide reliable validation of the cross-blockchain transaction associated with the plurality of blockchains and provides audits to ensure integrity of the cross-blockchain transaction.

Embodiments of the present disclosure are explained with reference to the accompanying drawings.

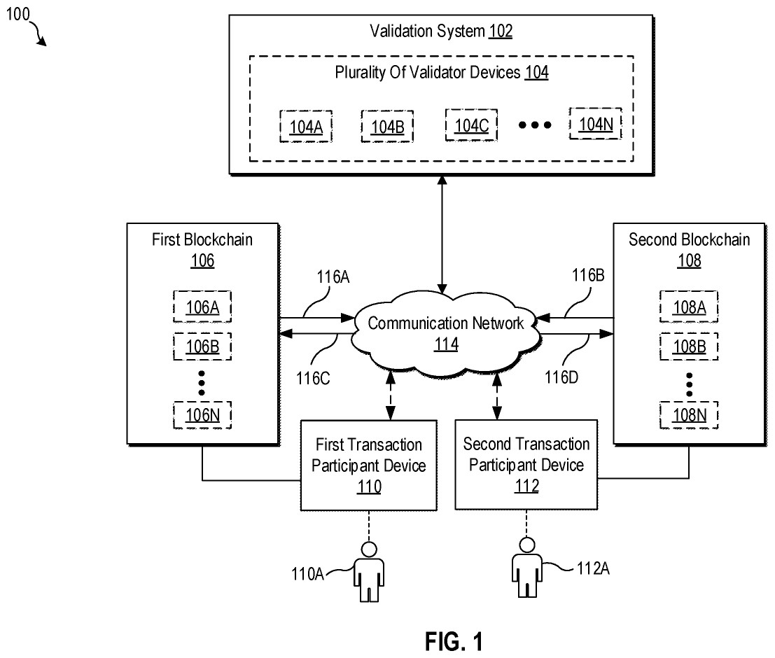

FIG. 1 is a diagram representing an example environment related to validation of the cross-blockchain transactions, arranged in accordance with at least one embodiment described in the present disclosure. With reference to FIG. 1, there is shown an environment 100. The environment 100 may include a validation system 102. The validation system 102 may include a plurality of validator devices 104, such as a first validator device 104A, a second validator device 104B, a third validator device 104C, and an Nth validator device 104N. Furthermore, the environment 100 may further include a plurality of blockchains, such as a first blockchain 106 and a second blockchain 108. The first blockchain 106 may include a first set of consensus devices 106A-106N. Moreover, the second blockchain 108 may include a second set of consensus devices 108A-108N. Furthermore, the environment may include a first transaction participant device 110 associated with the first blockchain 106 and a second transaction participant device 112 associated with the second blockchain 108. In an embodiment, the first set of consensus devices 106A-106N and the first transaction participant device 110 may be collectively referred as a first set of participant devices. The second set of consensus devices 108A-108N and the second transaction participant device 112 may be collectively referred to as a second set of participant devices. In an example, the first transaction participant device 110 and the second transaction participant device 112 may be considered as a plurality of transaction participant devices for a particular cross-blockchain transaction. Moreover, a first user 110A may be associated with the first transaction participant device 110 of the first blockchain 106. Similarly, a second user 112A may be associated with the second transaction participant device 112 of the second blockchain 108. Furthermore, a plurality of users (not shown in FIG. 1) may be associated with the first set of consensus devices 106A-106N and the second set of consensus devices 108A-108N. In accordance with an embodiment, the first user 110A may communicate with the second blockchain 108, whereas the second user 112A may also communicate with the first blockchain 106. It may be noted that only one transaction participation device (such as first transaction participant device 110 or the second transaction participant device 112) shown for the first blockchain 106 and the second blockchain 108, respectively in FIG. 1 is merely an example. The environment 100 may include N number of transaction participation devices, without deviation from the scope of the disclosure.

The validation system 102 may communicate with the plurality of blockchains, such as the first blockchain 106 and the second blockchain 108 via a communication network 114. In FIG. 1, there is further shown a cross-blockchain transaction 116A-116D which may be associated with the first transaction participant device 110 and the second transaction participant device 112. The cross-blockchain transaction 116A-116D may include a first transaction 116A, a second transaction 116B, a third transaction 116C, and a fourth transaction 116D. In an embodiment, the first transaction 116A and the third transaction 116C may be a first set of transactions that may be transmitted and received, respectively, by the first transaction participant device 110 of the first blockchain 106. On the other hand, the second transaction 116B and the fourth transaction 116D may be a second set of transactions that may be transmitted and received, respectively, by the second transaction participant device 112 of the second blockchain 108. The cross-blockchain transaction 116A-116D may be communicated with the validation system 102 for the validation of the cross-blockchain transaction 116A-116D. The cross-blockchain transaction 116A-116D may be referred, hereinafter, as a plurality of transaction including the first transaction 116A, the second transaction 116B, the third transaction 116C, and the fourth transaction 116D.

In accordance with an embodiment, the plurality of validator devices 104 may be present outside the validation system 102 and the validation system 102 may communicate with the plurality of validator devices 104 via the communication network 114. It may be noted that number of the plurality of validator devices 104, the plurality of blockchains, the first set of consensus devices 106A-106N, the second set of consensus devices 108A-108N, the first transaction participant device 110, the second transaction participant device 112 and users, such as the first user 110A and the second user 112A, in FIG. 1 are presented merely as an example. The environment 100 may include any number of the plurality of validator devices 104, the plurality of blockchains, the first set of consensus devices 106A-106N, the second set of consensus devices 108A-108N, the first transaction participant device 110, the second transaction participant device 112, and the users without deviation from the scope of the disclosure.

The validation system 102 may comprise suitable logic, circuitry, interfaces, and/or code that may be configured to perform one or more operations related to the validation of the cross-blockchain transaction, such as the cross-blockchain transaction 116A-116D associated with the first transaction participant device 110 and the second transaction participant device 112. The validation system 102 may be further configured to perform audit to verify integrity of the plurality of validator devices 104. In an exemplary implementation, the validation system 102 may be a blockchain based system. The blockchain based system may include a plurality of nodes, such as the plurality of validator devices 104. The first blockchain 106 and/or the second blockchain 108 may communicate with the validation system 102 via the plurality of nodes for execution or application of an extended smart contract for the validation of the cross-blockchain transaction 116A-116D. Examples of the validation system 102 may include, but are not limited to, a controlling system, a data analyzer system, a computing system, a smartphone, a cellular phone, a mobile phone, a mainframe machine, a server, a computer workstation, a laptop, or a desktop computer.

The plurality of validator devices 104 may include suitable logic, circuitry, interfaces and/or code that may be configured to apply the extended smart contract for the validation of the cross-blockchain transaction 116A-116D. The plurality of validator devices 104 may be a part of the validation system 102 as the blockchain based system, that may be present on the validation system 102 as participant devices for the validation of the cross-blockchain transaction 116A-116D. Moreover, in some embodiments, the plurality of validator devices 104 may be external devices that may communicate with the validation system 102 for the validation of the cross-blockchain transaction 116A-116D. Examples of the plurality of validator devices 104 may include, but are not limited to, a controlling device, a data analyzer device, a computing device, a smartphone, a cellular phone, a mobile phone, a mainframe machine, a server, a computer workstation, a laptop, or a desktop computer.

The plurality of blockchains, such as the first blockchain 106 and the second blockchain 108 may be decentralized and distributed database systems that may maintain or manage an immutable record of data operations. A set of data operations may be grouped together as a block and may be further linked to a previous block of the data operations to form a chain of a plurality of blocks. For example, any data such as data related to the transactions may be stored in the plurality of blockchains in form of the plurality of blocks. All blocks of the data operations may be stored in a decentralized manner, whereby all authorized participant devices or nodes, such as the first set of participant devices and the second set of participant devices may store data or access all the plurality of blocks. For example, the first transaction participant device 110 may access all the plurality of blocks in the first blockchain 106, whereas the second transaction participant device 112 of the second blockchain 108 may access all the plurality of blocks in the second blockchain 108. Moreover, the first set of consensus devices 106A-106N may access all the plurality of blocks in the first blockchain 106, whereas the second set of consensus devices 108A-108N may access all the plurality of blocks in the second blockchain 108. The first blockchain 106 may be different from the second blockchain 108. By way of example, and not limitation, the plurality of blockchains, such as the first blockchain 106 and the second blockchain 108 may be a Hyperledger blockchain, a Corda blockchain, an Ethereum blockchain, an Amazon Quantum Ledger Database (QLDB), a BigChain database (DB) blockchain.

In some embodiments, the plurality of blockchains may include an operating system (for example, a Java Virtual Machine (JVM)) which may allow deployment of the extended smart contract between multiple parties, for example, the first transaction participant device 110 of the first blockchain 106 and the second transaction participant device 112 of the second blockchain 108. The extended smart contract may be associated with the plurality of blockchains, the first set of participant devices and the second set of participant devices. In an exemplary scenario, the extended smart contract may be applied by the first validator device 104A of the plurality of validator devices 104.

The communication network 114 may include a communication medium through which the plurality of blockchains (such as the first blockchain 106 and the second blockchain 108), the first transaction participant device 110, the second transaction participant device 112 and the validation system 102 may communicate with each other. The communication network 114 may be one of a wired connection or a wireless connection. Examples of the communication network 114 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the environment 100 may be configured to connect to the communication network 114 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In operation, the validation system 102 may be configured to receive the first transaction 116A of the cross-blockchain transaction 116A-116D from the first transaction participant device 110 of the first blockchain 106, via the communication network 114. Moreover, the validation system 102 may be configured to receive the second transaction 116B of the cross-blockchain transaction 116A-116D from the second transaction participant device 112 of the second blockchain 108, via the communication network 114.

In an exemplary scenario, the cross-blockchain transaction 116A-116D may be associated with purchase of a product, such as a book. In such a case, the first user 110A may utilize the first transaction participant device 110 associated with the first blockchain 106 for the purchase of the book from an online store. On the other hand, a digital account of an owner (such as the second user 112A) of the online store may be present on the second blockchain 108. Therefore, the second user 112A may utilize the second transaction participant device 112 to sell products and receive currency in return of the sold products via the second blockchain 108. Thus, to have a trusted cross-blockchain transaction 116A-116D between the first blockchain 106 and the second blockchain 108, the validation system 102 may be needed in between to validate the cross-blockchain transaction 116A-116D of the first blockchain 106 and the second blockchain 108. In accordance with an embodiment, the first transaction 116A may be associated with placing a pre-paid order (for example, in form of cryptocurrency) for the purchase of the book. The placing of the pre-paid order may be initiated as the first transaction 116A by the first transaction participant device 110 of the first blockchain 106. Thus, the validation system 102 may receive the first transaction 116A from the first transaction participant device 110 for the validation. Similarly, the validation system 102 may receive processing of the placed pre-paid order as the second transaction 116B via the second transaction participant device 112 of the second blockchain 108. In some embodiments, the first transaction 116A and the second transaction 116B may further include information related to a destination of each of the first transaction 116A and the second transaction 116B. For example, the first transaction 116A may include the information that the first transaction 116A may be required at the second blockchain 108. Similarly, the second transaction 116B may include the information that the second transaction 116B may be required at the first blockchain 106. The information related to the destination of the first transaction 116A and the second transaction 116B may be required by the validation system 102 for the validation. In accordance with an embodiment, the received first transaction 116A and the second transaction 116B of the cross-blockchain transaction 116A-116D may be signed (for example, digitally signed) by the plurality of transaction participant devices, such as the first transaction 116A may be signed by the first transaction participant device 110 and the second transaction 116B may be signed by the second transaction participant device 112.

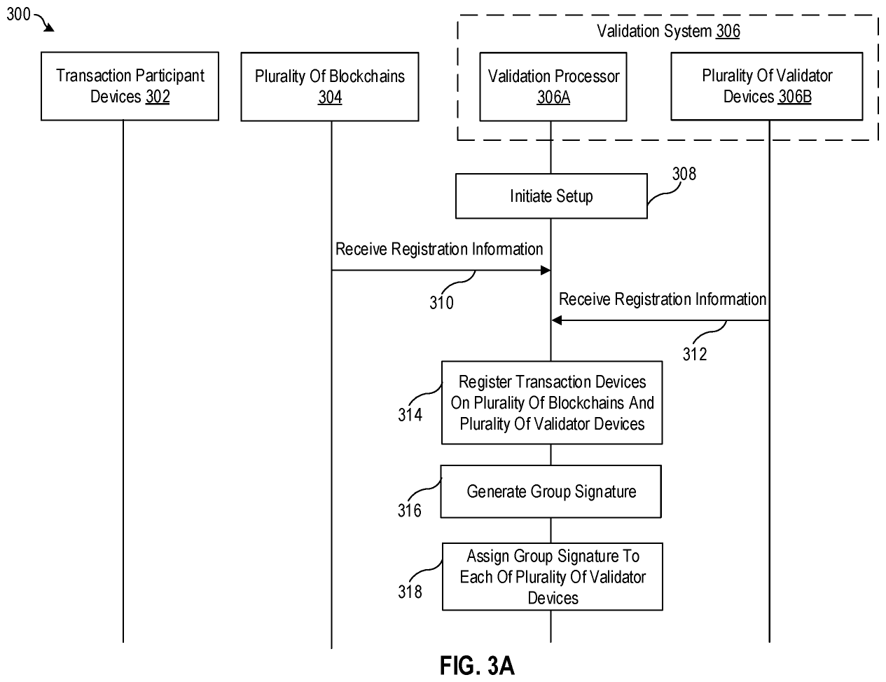

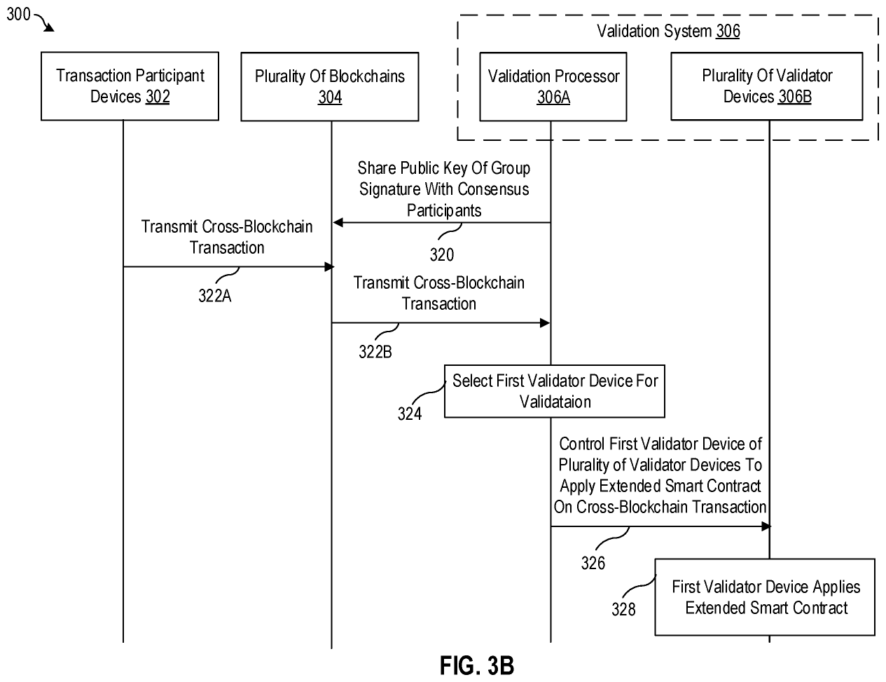

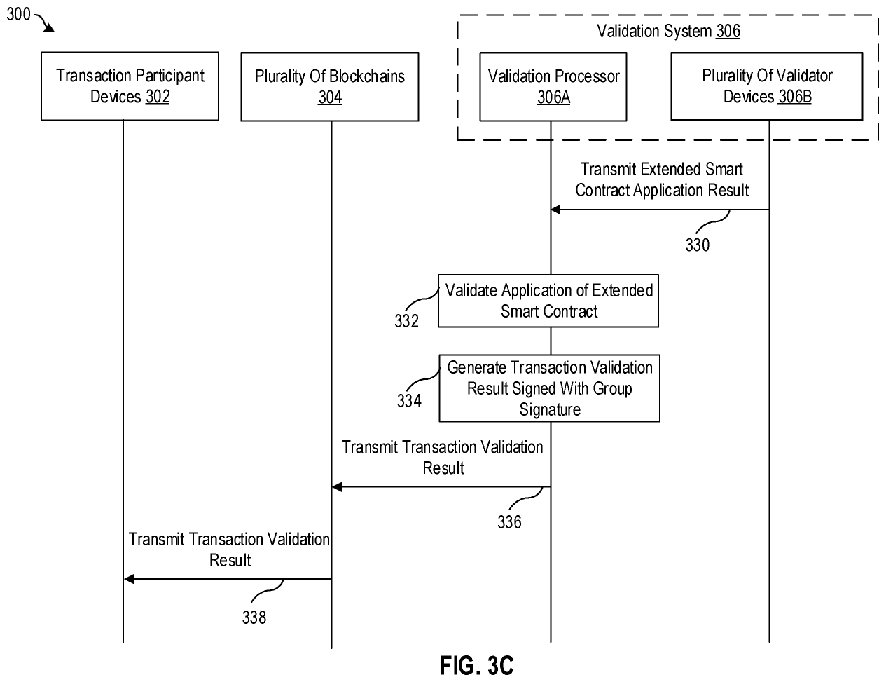

The validation system 102 may be further configured to control the first validator device 104A of the plurality of validator devices 104 to apply the extended smart contract on the received first transaction 116A and the second transaction 116B of the cross-blockchain transaction 116A-116D. It may be noted that the validation system 102 may control any validator device of the plurality of validator devices 104 based on availability of a particular validator device. In accordance with an embodiment, the validation system 102 may receive a request from the first transaction participant device 110 to select the first validator device 104A for the validation of the first transaction 116A and the second transaction 116B of the cross-blockchain transaction 116A-116D. However, identity information of the first validator device 104A may be unknown to the first transaction participant device 110 and the second transaction participant device 112 of the plurality of transaction participant devices. The extended smart contract may be applied on the received first transaction 116A and the second transaction 116B to check whether the first transaction 116A and the second transaction 116B are valid transactions according to the extended smart contract. The details of the application of the extended smart contract on the received first transaction 116A and the second transaction 116B are provided, for example, in FIGS. 3A-3C.

The validation system 102 may be further configured to validate or verify the application of the extended smart contract on the received first transaction 116A and the second transaction 116B of the cross-blockchain transaction 116A-116D based on the group signature assigned to each of the plurality of validator devices 104. The group signature may be generated and assigned to each of the plurality of validator devices 104. The details of the generation of the group signature by the validation system 102 are provided, for example, in FIGS. 3A-3C.

Moreover, the validation system 102 may be configured to generate a transaction validation result, based on the verification of the received first transaction 116A and the second transaction 116B. The validation system 102 may generate the transaction validation result, such that the transaction validation result may be signed with the group signature. Such transaction validation result signed with the group signature may assure that the transaction validation result is authentic, as the group signature may be generated by the validator system 102 and may be provided only to the registered and trusted plurality of validator devices 104. The details of the generation of the transaction validation result by the validation system 102 are provided, for example, in FIGS. 3A-3C.

The validation system 102 may be further configured to transmit the generated transaction validation result (i.e. associated with the validation of the received first transaction 116A and the second transaction 116B of the cross-blockchain transaction 116A-116D) to the plurality of blockchains. In accordance with an embodiment, the validation system 102 may control the first validator device 104A to apply the extended smart contract for the verification of the first transaction 116A and the second transaction 116B, and transmit the generated transaction validation result associated with the first transaction 116A and the second transaction 116B to the respective plurality of blockchains. In an exemplary scenario, the validation system 102 may transmit the generated transaction validation result (i.e. signed with the group signature) to the first blockchain 106 as the third transaction 116C, via the communication network 114. Similarly, the validation system 102 may transmit the generated transaction validation result (i.e. signed with the group signature) to the second blockchain 108 as the fourth transaction 116D, via the communication network 114. The details of the transmission of the transaction validation result signed with the group signature by the validation system 102 are provided, for example, in FIGS. 3A-3C. In an exemplary scenario, the first transaction participant device 110 and the second transaction participant device 112 may receive the transaction validation result (i.e. signed with the group signature) that may include information related to success or failure of the verification of the cross-blockchain transaction 116A-116D. The first transaction participant device 110 and the second transaction participant device 112 of the cross-blockchain transaction 116A-116D may check for validator's endorsement based on verification of the group signature in the signed transaction validation result received from the validation system 102. The details of the success or failure of the verification of the cross-blockchain transaction 116A-116D are provided, for example, in FIGS. 3A-3C. Thus, the validation system 102 may provide assurance to the first user 110A and the second user 112A that the cross-blockchain transaction 116A-116D between them may be authenticated and verified by the first validator device 104A of the plurality of validator devices 104. Moreover, the identity information of the first validator device 104A may be unknown to each of the first transaction participant device 110 and the second transaction participant device 112, and consequently to each of the first user 110A and the second user 112A.

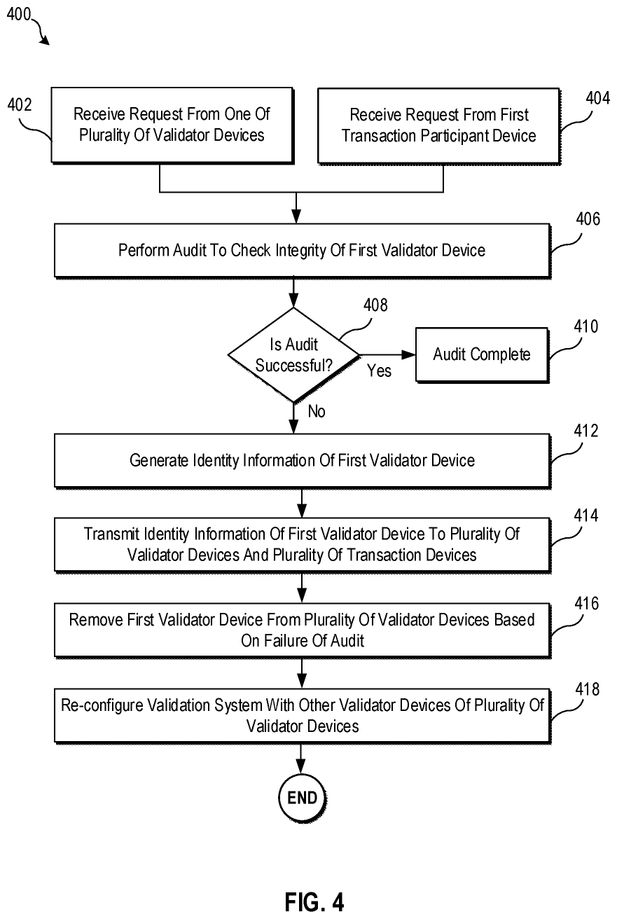

In accordance with an embodiment, the validation system 102 may be configured to perform an audit (for example a first audit or a second audit) to verify an integrity of the first validator device 104A for the validation performed on the cross-blockchain transaction 116A-116D. For example, the first validator device 104A may be a dishonest validator device that may forge the application of the extended smart contract to validate an unauthentic cross-blockchain transaction. Therefore, the validation system 102 may further perform the first audit at a predefined interval or the second audit based on a request received from a transaction participant device, such as the first transaction participant device 110 or the second transaction participant device 112. The details of the audits performed by the validation system 102 are provided, for example, in FIG. 4.

In accordance with an embodiment, the validation system 102 may be further configured to generate the identity information of the first validator device 104A of the plurality of validator devices 104, based on a failure of the audit (such as the first audit or the second audit) performed by the validation system 102. Moreover, the validation system 102 may be further configured to transmit the identity information of the first validator device 104A of the plurality of validator devices 104 to the first transaction participant device 110 and the plurality of validator devices 104. The validation system 102 may be configured to deanonymize the first validator device 104A from the plurality of validator devices 104 based on the failure of the audit. Furthermore, the validation system 102 may re-configure the validation system 102 with other validator devices (i.e. other than the first validator device 104A) of the plurality of validator devices 104. Thus, the dishonest validator device may be prohibited from performing any future validations on the transaction received from the plurality of blockchains, thereby ensuring authentic validation of the cross-blockchain transaction 116A-116D. The details of the generation of the identity information, the transmission of the generated identity information, and the re-configuration of the plurality of validator devices 104 by the validation system 102 are provided, for example, in FIG. 4.

Modifications, additions, or omissions may be made to FIG. 1 without departing from the scope of the present disclosure. For example, the environment 100 may include more or fewer elements than those illustrated and described in the present disclosure. For instance, in some embodiments, the functionality of the plurality of validator devices 104 may be incorporated into the validation system 102, without a deviation from the scope of the disclosure.

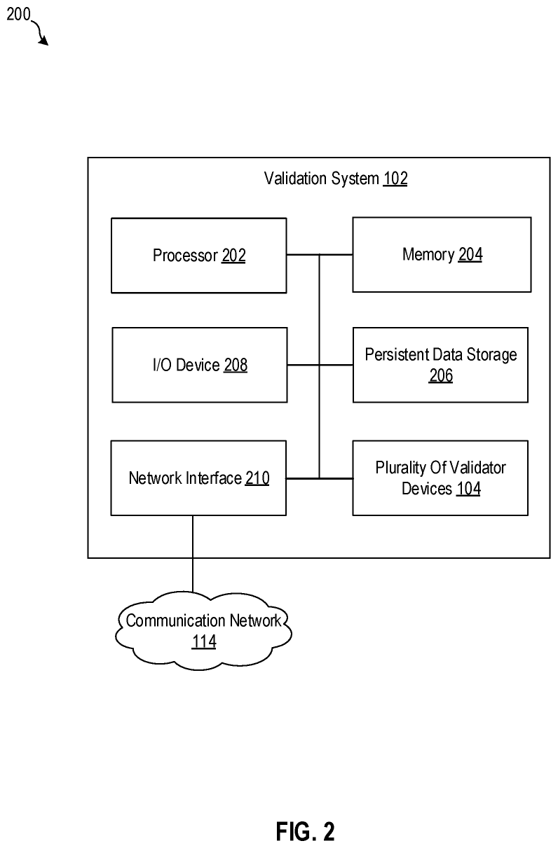

FIG. 2 is a block diagram that illustrates an exemplary validation system for the validation of a cross-blockchain transaction, arranged in accordance with at least one embodiment described in the present disclosure. FIG. 2 is explained in conjunction with elements from FIG. 1. With reference to FIG. 2, there is shown a block diagram 200 of the validation system 102. The validation system 102 may include a processor 202, a memory 204, a persistent data storage 206, an input/output (I/O) device 208, a network interface 210, and the plurality of validator devices 104.

The processor 202 may comprise suitable logic, circuitry, and/or interfaces that may be configured to execute program instructions associated with different operations to be executed by the validation system 102. For example, some of the operations may include, but are not limited to, reception of the first transaction 116A and the second transaction 116B of the cross-blockchain transaction 116A-116D, control of the first validator device 104A of the plurality of validator devices 104 to apply the extended smart contract on the cross-blockchain transaction 116A-116D (i.e. the first transaction 116A and the second transaction 116B associated with the plurality of blockchains), validation of the application of the extended smart contract on the cross-blockchain transaction 116A-116D based on the group signature assigned to each of the plurality of validator devices 104, generation of the transaction validation result, and transmission of the generate transaction validation result to the plurality of blockchains. The processor 202 may include any suitable special-purpose or general-purpose computer, computing entity, or processing device including various computer hardware or software modules and may be configured to execute instructions stored on any applicable computer-readable storage media. For example, the processor 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, the processor 202 may include any number of processors configured to, individually or collectively, perform or direct performance of any number of operations of the validation system 102, as described in the present disclosure. Additionally, one or more of the processors may be present on one or more different electronic devices, such as different servers.

In some embodiments, the processor 202 may be configured to interpret and/or execute program instructions and/or process data stored in the memory 204 and/or the persistent data storage 206. In some embodiments, the processor 202 may fetch program instructions from the persistent data storage 206 and load the program instructions in the memory 204. After the program instructions are loaded into the memory 204, the processor 202 may execute the program instructions. Some of the examples of the processor 202 may be a graphics processing unit (GPU), a central processing unit (CPU), a Reduced Instruction Set Computer (RISC) processor, an application-specific integrated circuit (ASIC) processor, a complex instruction set computer (CISC) processor, a co-processor, and/or a combination thereof.

The memory 204 may comprise suitable logic, circuitry, and/or interfaces that may be configured to store program instructions executable by the processor 202. In certain embodiments, the memory 204 may be configured to store operating systems and associated application-specific information. The memory 204 may include computer-readable storage media for carrying or having computer-executable instructions or data structures stored thereon. Such computer-readable storage media may include any available media that may be accessed by a general-purpose or special-purpose computer, such as the processor 202. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 202 to perform a certain operation or group of operations associated with the validation system 102.

The persistent data storage 206 may comprise suitable logic, circuitry, and/or interfaces that may be configured to store program instructions executable by the processor 202, operating systems, and/or application-specific information, such as logs and application-specific databases. The persistent data storage 206 may include computer-readable storage media for carrying or having computer-executable instructions or data structures stored thereon. Such computer-readable storage media may include any available media that may be accessed by a general-purpose or special-purpose computer, such as the processor 202.

By way of example, and not limitation, such computer-readable storage media may include tangible or non-transitory computer-readable storage media including Compact Disc Read-Only Memory (CD-ROM) or other optical disk storage, magnetic disk storage or other magnetic storage devices (e.g., Hard-Disk Drive (HDD)), flash memory devices (e.g., Solid State Drive (SSD), Secure Digital (SD) card, other solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 202 to perform a certain operation or group of operations associated with the validation system 102.

In some embodiments, either of the memory 204, the persistent data storage 206, or combination may store the cross-blockchain transaction 116A-116D, and the transaction validation result signed with the group signature. The processor 202 may fetch the first transaction 116A and the second transaction 116B of the cross-blockchain transaction 116A-116D (i.e. to perform different operations of the disclosed validation system 102) from the memory 204, the persistent data storage 206 or combination. In some embodiments, either of the memory 204, the persistent data storage 206, or combination may store the generated group signature, and registration information associated with the plurality of validator devices 104 and the plurality of blockchains. The details of the registration information associated with the plurality of validator devices 104 and the plurality of blockchains are provided, for example, in FIG. 4.

The I/O device 208 may include suitable logic, circuitry, interfaces, and/or code that may be configured to receive a user input. For example, the validation system 102 may receive the user input from the plurality of validator devices 104 to register the plurality of validator devices 104 on the validation system 102. Moreover, the I/O device 208 may be configured to receive the audit request from any of the plurality of validator devices 104. The I/O device 208 may further be configured to display the generated identity information associated with the dishonest validator device. The I/O device 208 may include various input and output devices, which may be configured to communicate with the processor 202 and other components, such as the network interface 210. Examples of the input devices may include, but are not limited to, a touch screen, a keyboard, a mouse, a joystick, and/or a microphone. Examples of the output devices may include, but are not limited to, a display and a speaker.

The network interface 210 may comprise suitable logic, circuitry, interfaces, and/or code that may be configured to establish a communication between the validation system 102 and the plurality of blockchains, such as the first blockchain 106 and the second blockchain 108, via the communication network 114. The network interface 210 may be implemented by use of various known technologies to support wired or wireless communication of the validation system 102 via the communication network 114. The network interface 210 may include, but is not limited to, an antenna, a radio frequency (RF) transceiver, one or more amplifiers, a tuner, one or more oscillators, a digital signal processor, a coder-decoder (CODEC) chipset, a subscriber identity information module (SIM) card, and/or a local buffer.

The network interface 210 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), light fidelity (Li-Fi), or Wi-MAX.

Modifications, additions, or omissions may be made to the example validation system 102 without departing from the scope of the present disclosure. For example, in some embodiments, the example validation system 102 may include any number of other components that may not be explicitly illustrated or described for the sake of brevity.

FIGS. 3A-3C collectively illustrate an exemplary sequence diagram depicting the validation of the cross-blockchain transactions by the validation system of FIG. 1, in accordance with an embodiment of the disclosure. FIGS. 3A-3C are explained in conjunction with elements from FIG. 1 and FIG. 2. With reference to FIGS. 3A-3C, there is shown a sequence diagram 300 which illustrates a sequence of operations from 308 to 338. The sequence of operations may be executed by various elements of the environment 100, such as, but not limited to, a plurality of transaction participant devices 302 (such as the first transaction participant device 110 and the second transaction participant device 112), the plurality of blockchains (represented as a plurality of blockchains 304) and the validation system 102 (represented as a validation system 306). Further, the sequence of operations may be executed by the processor 202 of FIG. 2 (represented as a validation processor 306A) and the plurality of validator devices 104 (represented as a plurality of validator devices 306B). The functions of the validation processor 306A may be same as the functions of the processor 202 described, for example, in FIG. 2. Therefore, the description of the validation processor 306A is omitted from the disclosure for the sake of brevity.

At 308, a setup may be initiated. In accordance with an embodiment, the validation processor 306A of the validation system 306 may be configured to initiate the setup. In some embodiments, the validation processor 306A may initiate the setup based on a notification received from one or more of the plurality of blockchains 304 corresponding to a requirement of validation of the first transaction 116A and the second transaction 116B of the cross-blockchain transaction 116A-116D associated with the plurality of blockchains 304. In another embodiment, the validation processor 306A may initiate the setup during formation of the extended smart contract between the validation system 306, the plurality of blockchains 304, the first set of participant devices and the second set of participant devices. In an exemplary scenario, the extended smart contract may include rules of transactions applicable for a cross-blockchain transaction (for example, the cross-blockchain transaction 116A-116D). In yet another embodiment, the validation processor 306A may control the plurality of validator devices 306B to initiate the setup.

At 310, registration information may be received from the plurality of blockchains 304. In accordance with an embodiment, the validation processor 306A may be configured to receive the registration information from the plurality of blockchains 304, such as the first blockchain 106 and the second blockchain 108. The registration information may include information related to the first set of participant devices and the second set of participant devices. associated with the plurality of blockchains 304. For example, the information may include, but not limited to, a device identifier, an IP address, geo-location, or user information. Moreover, the registration information may include information related to a plurality of transaction participants such as the first user 110A (for example a first transaction participant) associated with the first transaction participant device 110 and the second user 112A (for example a second transaction participant) associated with the second transaction participant device 112. For example, the information may include, but not limited to, user name, user email address, contact details, or educational details.

At 312, registration information associated with the plurality of validator devices 306B may be received. In accordance with an embodiment, the validation processor 306A of the validation system 306 may receive the registration information associated with the plurality of validator devices 306B. The registration information may include information associated with each validator device of the plurality of validator devices 306B. For example, the information associated with the plurality of validator devices 306B may include, but not limited to, a device identifier, an IP address, geo-location, or organization associated with validator device. Moreover, the registration information may include information related to the validators associated with the plurality of validator devices 306B. For example, the information associated with the validators may include, but not limited to, an organization, an individual name, contact details, an email address, or validation experience.

At 314, the plurality of blockchains 304 and the plurality of validator devices 306B may be registered in the validation system 306 as a part of the initial setup. The plurality of blockchains 304 and the plurality of validator devices 306B may be registered based on the received registration information (at 310 and 312). In accordance with an embodiment, the validation processor 306A may be configured to register the first set of participant devices (i.e. that includes the first transaction participant device 110 and the first set of consensus devices 106A-106N), the second set of participant devices (i.e. that includes the second transaction participant device 112 and the second set of consensus devices 108A-108N), the plurality of blockchains 304 (such as the first blockchain 106 and the second blockchain 108), and the plurality of validator devices 306B. In some embodiments, the validation processor 306A may further register a set of security parameters associated with a multiparty computation (MPC) scheme which may be utilized by the validation system 306 for the communication with the plurality of blockchains 304. In the MPC scheme, all concerned parties, such as the plurality of blockchains 304 (or corresponding nodes) may be updated simultaneously. For example, any cross-blockchain transaction that may take place between the first blockchain 106 and the second blockchain 108 may be updated at respective nodes (or the transaction participant devices) on both the first blockchain 106 and the second blockchain 108. Thus, the MPC may allow transparency in the transactions between multiple parties (such as the plurality of blockchains 304). In one or embodiments, the registered set of security parameters may differ based on a type of MPC scheme utilized by the validation system 306. In an embodiment, the validation system 306 may utilize a secret sharing protocol other than the convention MPC scheme for communication between the validation system 306 and the plurality of blockchains.

At 316, the group signature may be generated. In accordance with an embodiment, the validation processor 306A may be configured to generate the group signature for the plurality of validator devices 306B. The group signature may include, for example, a digital signature that may include a property, that any device of the validation system 102 with the group signature may anonymously sign a message (such as the cross-blockchain transaction 116A-116D) using the group signature. Thus, the group signature may provide anonymity to the device (such as a signer) that has signed the message using the group signature. Moreover, the group signature may further possess a property that any device with the group signature may not frame or misuse other devices possessing the group signature. The group signature may include a public key (and a corresponding private key) and a master secret key (MSK). The validation processor 306A may be configured to generate the public key and the master secret key as a part of the group signature by using a randomized algorithm that may take a number of validator devices of the plurality of validator devices 306B as an input.

The group signature may be implemented by use of one or more algorithms. In an exemplary scenario, the validation processor 306A may utilize different algorithms for the implementation of the group signature. An exemplary algorithm for the generation of the group signature is indicated below:

Setup (public key, master secret key). KeyGen (Master secret key, i); i.e. to get a signing key corresponding to “i”,

The group signature may include the public key (and the corresponding private key) and the master secret key. The algorithm for the generation of the group signature may take input as the number of validator devices and may further utilize a bilinear group pair generation to generate the public key (and the corresponding private key) and the master secret key.

An exemplary algorithm for signing of the transaction validation result is described as follows:

Sign (transaction message, signing key corresponding to “i”); i.e. to get signature (σ). The signing of the transaction validation result is described, for example, at 334 in FIG. 3C.

An exemplary algorithm for verification of the signature (σ) is described as follows:

Verify (transaction message, signature (σ), public key); i.e. to get a result as “0” or “1”

The integrity of a validator device of the plurality of validator devices 306B may be checked by verification of the group signature on the cross-blockchain transaction 116A-116D as explained for example, in FIG. 4.

An exemplary algorithm for deanonymization of validator device of the plurality of validator devices 306B is described as follows:

Deanonymize (transaction message, signature (σ), Master secret key); i.e. to get a result as “1”, i.e., to deanonymize a validator device based on a failure of an audit (such as the first audit or the second audit),

wherein “i” corresponds to a unique validator device of the plurality of validator devices 104.

The deanonymization of the validator device based on the failure of the audit (such as the first audit or the second audit) is explained, for example, in FIG. 4.

The master secret key may include an individual signing key indicative of an identity of a respective validator device of the plurality of validator devices 306B. Thus, the master secret key may be stored in the validation system 306 at a secure database (such as a cold storage) for the auditing purposes. The details of the usage of the master secret key for the auditing, are described, for example, in FIG. 4. Thus, the validation system 306 may utilize the group signature for maintaining enhanced privacy or anonymity of the plurality of validator devices 306B in validation of the cross-blockchain transaction 116A-116D.

At 318, the generated group signature may be assigned to the plurality of validator devices 306B. In accordance with an embodiment, the validation processor 306A may be configured to assign the generated group signature to each of the registered plurality of validator devices 306B that includes the first validator device 104A. In one or more embodiments, the validation processor 306A may share a threshold share of the master secret key with each of the plurality of validator devices 306B. The assigned group signature may include the public key as well as the threshold share of the master secret key that may include the individual signing key. For example, the group signature assigned to the first validator device 104A may include the public key and the threshold share of the master secret key, such that the threshold share of the master secret key may include the individual signing key that includes the identity information of the first validator device 104A. Thus, in case of auditing, the master secret key may be utilized to determine the identity information related to a dishonest validator device.

At 320, the public key of the generated group signature may be shared with the first set of consensus devices 106A-106N and the second set of consensus devices 108A-108N. In accordance with an embodiment, the validation processor 306A of the validation system 306 may be configured to share the public key with the first set of consensus devices 106A-106N and the second set of consensus devices 108A-108N of the first blockchain 106 and the second blockchain 108 respectively. Each of the first set of consensus devices 106A-106N and the second set of consensus devices 108A-108N may be an authorizing participant device on the plurality of blockchains 304 for authorization of the cross-blockchain transaction 116A-116D. Therefore, the validation processor 306A may share the public key with the first set of consensus devices 106A-106N and the second set of consensus devices 108A-108N on the plurality of blockchains 304. plurality of blockchains 304.

At 322A, the first transaction 116A and the second transaction 116B of the cross-blockchain transaction 116A-116D may be transmitted to the plurality of blockchains 304. In accordance with an embodiment, the plurality of transaction participant devices 302 may be configured to transmit the first transaction 116A and the second transaction 116B of the cross-blockchain transaction 116A-116D to the plurality of blockchains 304, of the via the communication network 114.

At 322B, the plurality of blockchains 304 may transmit the received first transaction 116A and the second transaction 116B of the cross-blockchain transaction 116A-116D to the validation processor 308A of the validation system 308. In accordance with an embodiment, each of the first transaction participant device 110 and the second transaction participant device 112 may agree on a trade that requires the cross-blockchain transaction 116A-116D. After the agreement of the first transaction participant device 110 may generate the first transaction 116A and the second transaction participant device 112 may generate the second transaction 116. In an embodiment, the first transaction 116A and the second transaction 116B of the cross-blockchain transaction 116A-116D may be received via the MPC scheme. In accordance with an embodiment, the received first transaction 116A and the second transaction 116B of the cross-blockchain transaction 116A-116D may be individually signed by the first transaction participant device 110 and the second transaction participant device 112 respectively.

At 324, the first validator device 104A may be selected from the plurality of validator devices 104. In accordance with an embodiment, the validation processor 306A may be configured to select the first validator device 104A from the plurality of validator devices 104 for validation of the cross-blockchain transaction 116A-116D received from the plurality of blockchains 304. In some embodiments, the validation system 306 may select the first validator device 104A based on the availability of the first validator device 104A from the plurality of validator devices 306B. In accordance with an embodiment, the validation processor 306A may receive a request from the first transaction participant device 110 or the second transaction participant device 112 of the plurality of transaction participant devices to select a validator device (such as the first validator device 104A) for the validation of the cross-blockchain transaction 116A-116D, though the identity of the first validator device 104A is unknown to the plurality of transaction participant devices. In an exemplary scenario, one of the plurality of transaction participant devices may transmit the request for the selection of the first validator device 104A via the I/O device 208 of FIG. 2.

At 326, the first validator device 104A may be controlled to apply the extended smart contract on the cross-blockchain transaction 116A-116D. In accordance with an embodiment, the validation processor 306A of the validation system 306 may be configured to control the first validator device 104A of the plurality of validator devices 104 to apply the extended smart contract on the first transaction 116A and the second transaction 116B of the cross-blockchain transaction 116A-116D. As the control, the validation processor 306A may transmit a request to the selected first validator device 104A to apply the extended smart contract on the cross-blockchain transaction. The application of the extended smart contract may ensure that the cross-blockchain transaction 116A-116D may be executed in accordance with the predefined rules and protocols specified in the extended smart contract. The extended smart contract may further include transaction information, for example, price of the product, such as the book requested by the first transaction participant device 110.

At 328, the extended smart contract may be applied for validation of the cross-blockchain transaction 116A-116D. In accordance with an embodiment, the selected first validator device 104A of the plurality of validator devices 306B may be configured to apply the extended smart contract for the validation of the cross-blockchain transaction 116A-116D. In an exemplary scenario, the cross-blockchain transaction 116A-116D may include transactions related to purchase of a product, such as a book. The pre-paid order may be placed by the first user 110A for the purchase of the book via the first transaction participant device 110 on the first blockchain 106. The pre-paid order may be processed by the second user 112A via the second transaction participant device 112 of the second blockchain 108. For example, the application of the extended smart contract may ensure that the amount paid by the first user 110A via the first transaction participant device 110 satisfies a predefined amount as specified in the extended smart contract. Moreover, the application of the extended smart contract may also ensure that the online store of the second user 112A associated with the second transaction participant device 112 has the pre-ordered book available for shipment. Thus, the first validator device 104A of the plurality of validator devices 306B may apply the extended smart contract to verify the validity of the cross-blockchain transaction 116A-116D.

At 330, a result of the application of the extended smart contract may be transmitted. The selected first validator device 104A of the plurality of validator devices 306B may be configured to transmit the result of the application of the extended smart contract to the validation processor 306A of the validation system 306. The result of the application of the extended smart contract may include information related to the authenticity of the cross-blockchain transaction 116A-116D. In an exemplary scenario, the result of the application of the extended smart contract may include the information that the first transaction 116A is authentic, if the first transaction 116A satisfies the predefined rules of the extended smart contract. Similarly, the result of the application of the extended smart contract may include that information that the second transaction 116B is authentic if the second transaction 116B satisfies the predefined rules of the extended smart contract. In another example, the result of the application of the extended smart contract may include information that the first transaction 116A is unauthentic, if the first transaction 116A dissatisfies the predefined rules of the extended smart contract. Similarly, the result of the application of the extended smart contract may include information that the second transaction 116B is unauthentic if the second transaction 116B dissatisfies the predefined rules of the extended smart contract.

At 332, the application of the extended smart contract may be validated. In accordance with an embodiment, the validation processor 306A of the validation system 306 may be configured to validate the application of the extended smart contract based on the result received (at 330) from the first validator device 104A of the plurality of validator devices 306B. For example, in case the received result is success or positive, the validation processor 306A of the validation system 306 may validate the application of the extended smart contract on the cross-blockchain transaction. In other words, the validation processor 306A may endorse the first transaction 116A and the second transaction 116B of the first blockchain 106 and the second blockchain 108 respectively based on the result received from the selected first validator device 104A about the application of the extended smart contract on the cross-blockchain transaction (i.e. including the first transaction 116A and the second transaction 116B). The endorsement of the first transaction 116A and the second transaction 116B of the cross-blockchain transaction 116A-116D may ensure that the extended smart contract has been correctly or successfully applied by the first validator device 104A of the plurality of validator devices 104. In another example, in case the received result from the selected first validator device 104A of the plurality of validator devices 306B is unsuccessful or negative, the validation processor 306A of the validation system 306 may invalidate the application of the extended smart contract on the cross-blockchain transaction.

At 334, a transaction validation result may be generated. In accordance with an embodiment, the validation processor 306A of the validation system 306 may be configured to generate the transaction validation result signed with the generated group signature. The transaction validation result may be generated based on the validation performed at 332. The transaction validation result may indicate that the application of the extended smart contract on the cross-blockchain transaction is validated (successful or positive) or invalidated (unsuccessful or negative). In some embodiment, the transaction validation result may further include for example, information about the first transaction 116A, the second transaction 116B, and the information related to the authenticity of the first transaction 116A, and the second transaction 116B of the cross-blockchain transaction 116A-116D. The transaction validation result signed with the generated group signature may signify that the cross-blockchain transaction 116A-116D has been validated by the external validator device, such as the first validator device 104A of the plurality of validator devices 104. In some embodiment, the generated transaction validation result may be binary information (for example “1” for successful validation/or “0” for unsuccessful validation).

At 336, the transaction validation result may be transmitted. In accordance with an embodiment, the validation processor 306A of the validation system 306 may be configured to transmit the transaction validation result (i.e. generated at 334) to the plurality of blockchains 304, such as the first blockchain 106 and the second blockchain 108. In an exemplary scenario, the transaction validation result may be transmitted to the first transaction participant device 110 of the first blockchain 106 as the third transaction 116C. Moreover, the transaction validation result may be transmitted to the second transaction participant device 112 of the second blockchain 108 as the fourth transaction 116D. The transaction validation result received by the first transaction participant device 110 and the second transaction participant device 112 may be signed with the group signature assigned to all the plurality of validator devices 306B (at 318). In some embodiments, the transaction validation result signed with the group signature may be shared with the first set of consensus devices 106A-106N and the second set of consensus devices 108A-108N. The consensus devices may verify the validation (i.e. performed by the first validator device 104A) based on the group signature. Thus, the first transaction participant device 110 and the second transaction participant device 112 may have an assurance that the cross-blockchain transaction 116A-116D may be validated by the trusted first validator device 104A of the plurality of validator devices 306B. However, the identity information of the first validator device 104A is unknown to the first transaction participant device 110 and the second transaction participant device 112, thereby ensuring maintenance of privacy of the first validator device 104A of the plurality of validator devices 306B. Since the group signature is commonly assigned to all the plurality of validator devices 306B (i.e. not uniquely assigned to an individual validator device), the first transaction participant device 110 and/or the second transaction participant device 112 (or the first user 110A and the second user 112A) may not be able to identify which external validator device (such as the first validator device 104A) is responsible or selected to validate the cross-blockchain transaction received (at 322A and 322B) from the plurality of blockchains 304 (including the first transaction participant device 110 and the second transaction participant device 112). Therefore, any dishonest user of the plurality of blockchains 304 (or the cross-blockchain transaction) may not be able to influence or bribe the selected validator to perform a fraudulent validation. Thus, the validation system 306 in the present disclosure may minimize frauds or cheating by a dishonest validator device, and provide reliable and authentic validation of the cross-blockchain transaction 116A-116D associated with the plurality of blockchains, such as the first blockchain 106 and the second blockchain 108.

At 338, the transaction validation result may be transmitted to the plurality of transaction participant devices 302. In an embodiment, the plurality of blockchains 304 may be configured to transmit the transaction validation result to the plurality of transaction participant devices 302. In some embodiments, the nodes (i.e. corresponding to the cross-blockchain transaction) of the first blockchain 106 and the second blockchain 108 may be updated based on the successful transaction validation result (received at 336) which is signed with the assigned group signature. In an embodiment, the first transaction participant device 110 of the first user 110A and the second transaction participant device 112 of the second user 112A may be notified for the completion of the cross-blockchain transaction 116A-116D at the plurality of blockchains 304. In some embodiments, the first validator device 104A may be notified about the completion of the cross-blockchain transaction 116A-116D.

FIG. 4 illustrates a flowchart of an example method related to audit performed by the validation system of FIG. 1, according to at least one embodiment described in the present disclosure. FIG. 4 is explained in conjunction with elements from FIG. 1, FIG. 2 and FIGS. 3A-3C. With reference to FIG. 4, there is shown a flowchart 400. The method illustrated in the flowchart 400 may start at 402 and may be performed by any suitable system, apparatus, or device, such as by the example validation system 102 of FIG. 1 or the processor 202 of FIG. 2. Although illustrated with discrete blocks, the steps and operations associated with one or more of the blocks of the method may be divided into additional blocks, combined into fewer blocks, or eliminated, depending on the particular implementation.

At 402, a request may be received from one of the plurality of validator devices 104 to perform a first audit. In accordance with an embodiment, the processor 202 (or the validation processor 306A in FIG. 3) may be configured to receive the request from one of the plurality of validator devices 104 to perform the first audit to further verify an integrity of the first validator device 104A who may have performed the validation of the cross-blockchain transaction 116A-116D. In an exemplary scenario, the processor 202 may receive the request from the first validator device 104A for the first audit. In one or more embodiments, the request may be received from a validator device of the plurality of validator devices 104 that may have not performed the validation of the cross-blockchain transaction 116A-116D. For example, the validator device may be different from the first validator device 104A which may have validated the cross-blockchain transaction 116A-116D. In an embodiment, the received request may include information about the cross-blockchain transaction 116A-116D regarding which the corresponding validator device has to be audited.

At 404, a request may be received from a transaction participant device (such as the first transaction participant device 110) of the first blockchain 106 to perform a second audit. In accordance with an embodiment, the processor 202 may be configured to receive the request from the first transaction participant device 110 of the first blockchain 106 to perform the second audit to further verify the integrity of the first validator device 104A who may have performed the validation of the cross-blockchain transaction 116A-116D. The processor 202 may receive the request from the first transaction participant device 110 to perform the second audit, for example, in case the first user 110A associated with the first transaction participant device 110 is unsure of the authenticity of the validation or endorsement performed by the first validator device 104A on the cross-blockchain transaction 116A-116D. In some embodiments, the processor 202 may receive the request from the second transaction participant device 112 of the second blockchain 108 to perform the second audit on the validation performed on the cross-blockchain transaction 116A-116D by the first transaction participant device 110. In an embodiment, the received request from the participant device may include information about the cross-blockchain transaction 116A-116D regarding which the corresponding validator device has to be audited.

It may be noted that 402 and 404 may be performed independent of each other. In an exemplary scenario, the processor 202 may receive the request either from the first validator device 104A to perform the first audit or the processor 202 may receive the request from the first transaction participant device 110 to perform the second audit. In another exemplary scenario, the processor 202 may receive the request from both the first validator device 104A and the first transaction participant device 110.

At 406, the audit (such as the first audit or the second audit) may be performed to verify the integrity of the first validator device 104A which may have performed the validation of the cross-blockchain transaction 116A-116D (for example as described for example, in 328-334 in FIG. 3). In accordance with an embodiment, the processor 202 may be configured to perform the audit (such as the first audit or the second audit based on the request received), to verify the integrity of the first validator device 104A of the plurality of validator devices 104.

In one or more embodiment, the processor 202 may be configured to perform the first audit at a predefined interval. In an example, the predefined interval may be, but not limited to, once a day, once a week, once a month, and so forth. The first audit performed at the predefined interval may ensure that all of the registered plurality of validator devices 104 are trusted validator devices.

In accordance with an embodiment, the processor 202 of the validation system 102 may perform the first audit or the second audit based on the control of each validator device of the plurality of validator devices 104 which performed the validation of the cross-blockchain transaction 116A-116D. In accordance with an embodiment, the processor 202 may be further configured to control each validator device of the plurality of validator devices 104 to perform the validation of the cross-blockchain transaction 116A-116D again to conduct the first audit or the second. In such a case, each validator device of the plurality of validator devices 104 may apply the extended smart contract on the cross-blockchain transaction 116A-116D. The processor 202 of the validation system 102 may further validate the application of the extended smart contract by each of the validator device of the plurality of validator devices 104 responsible for the validation of the cross-blockchain transaction 116A-116D earlier. The processor 202 of the validation system 102 may further generate a transaction validation result for the corresponding validator device based on the application of the extended smart contract on the cross-blockchain transaction 116A-116D. The processor 202 of the validation system 102 may be further configured to analyze the transaction validation result generated by the corresponding validator device of the plurality of validator devices 104. In an embodiment, as the analysis, the processor 202 of the validation system 102 may check if the transaction validation result generated during the audit matches with the transaction validation result generated during the validation (at 332). In some embodiment, the transaction validation result during the audit (at 406) and the transaction validation result during the validation (at 332) may be generated by different validator devices of the plurality of validator devices 104, such that the validation performed by one validator device may be verified or audited by other validator device, to enhance a quality of the audio process.

At 408, the successfulness of the audit may be determined. In accordance with an embodiment, the processor 202 of the validation system 102 may be configured to determine the successfulness of the performed audit (such as the first audit or the second audit). The validation system 102 may determine the audit as successful if the transaction validation results generated during the audit (performed at 406) and the validation (performed at 332) matches with each other. Moreover, the validation system 102 may further determine the audit as a failure if the transaction validation results generated during the audit (performed at 406) and the validation (performed at 332) differs from each other. In some embodiments, a predefined amount of the threshold share of the master secret key may be required to determine the successfulness or failure of the audit (i.e. the first audit or the second audit). In case of failure of the audio, the control may pass to 412, otherwise the control may pass to 410.

At 410, the audit may be completed if the audit is successful. In accordance with an embodiment, the processor 202 of the validation system 102 may be configured to complete the audit if the audit (such as the first audit or the second audit) is successful. In accordance with an embodiment, the plurality of validator devices 104 may receive information related to the success of the performed audit, if the audit is successful. In another embodiment, the first transaction participant device 110 (which may initiate the second audit at 404) may receive information related to the success of the performed audit, if the audit is successful.

At 412, identity information of the first validator device 104A of the plurality of validator devices 104 may be generated. In accordance with an embodiment, the processor 202 may be configured to generate the identity information of the first validator device 104A of the plurality of validator devices 104 based on the failure of the performed audit (at 406). In some embodiments, the identity information of the first validator device 104A may include, but not limited to, unique identification information (ID) the first validator device 104A. In one or more embodiments, the identity information of the first validator device 104A may include the master secret key that may include the individual signing key indicative of the identity of the first validator device 104A of the plurality of validator devices 104. In an embodiment, the processor 202 may be configured to generate the identity information of the first validator device 104A to indicate for which validator device the performed audit (i.e. first audit or the second audit) has failed. In such case, the identity information may indicate a dishonest validator (or dishonest validator device out of the plurality of validator devices 104).

At 414, the identity information of the first validator device 104A of the plurality of validator devices 104 may be transmitted. In accordance with an embodiment, the processor 202 of the validation system 102 may be configured to transmit the generated identity information of the first validator device 104A of the plurality of validator devices 104 to the plurality of validator devices 104 and the plurality of transaction participant devices, such as the first transaction participant device 110 and the second transaction participant device 112. The transmitted identity information including the individual signing key may allow the plurality of validator devices 104 and the plurality of transaction participant devices to identify the dishonest validator device (for example the first validator device 104A if the first validator device 104A fails the audit) from the plurality of validator devices 104.

At 416, the first validator device 104A may be removed from the plurality of validator devices 104 based on the failure of the audit. In accordance with an embodiment, the processor 202 of the validation system 102 may be configured to remove (or deanonymize) the first validator device 104A from the plurality of validator devices 104 based on the failure of the audit (such as the first audit or the second audit) performed for the first validator device 104A. In an embodiment, the predefined amount of the threshold share of the master secret key may be required for the removal of the first validator device 104A from the plurality of validator devices 104 based on the failure of the audit. Thus, the validation system 102 may remove any validator device that fails the audit, such that only the trusted validator devices may be only controlled in order to validate the cross-blockchain transaction 116A-116D, not the dishonest validators (or validators devices).

At 418, the validation system 102 may be re-configured. In accordance with an embodiment, the processor 202 of the validation system 102 may be configured to re-configure the validation system 102 with the other validator devices of the plurality of validator devices 104 after removal of the first validator device 104A based on the failure of the audit. The processor 202 may re-configure (or re-setup) the validation system 102 with the other validator devices of the plurality of validator devices 104 by performing the operation from 308 till 320 as explained in FIGS. 3A-3B, with the exclusion of the first validator device 104A from the plurality of validator devices 104.

Control passes to end. Although the flowchart 400 is illustrated as discrete operations, such as 402, 404, 406, 408, 410, 412, 414, 416 and 418. However, in certain embodiments, such discrete operations may be further divided into additional operations, combined into fewer operations, or eliminated, depending on the particular implementation without detracting from the essence of the disclosed embodiments.

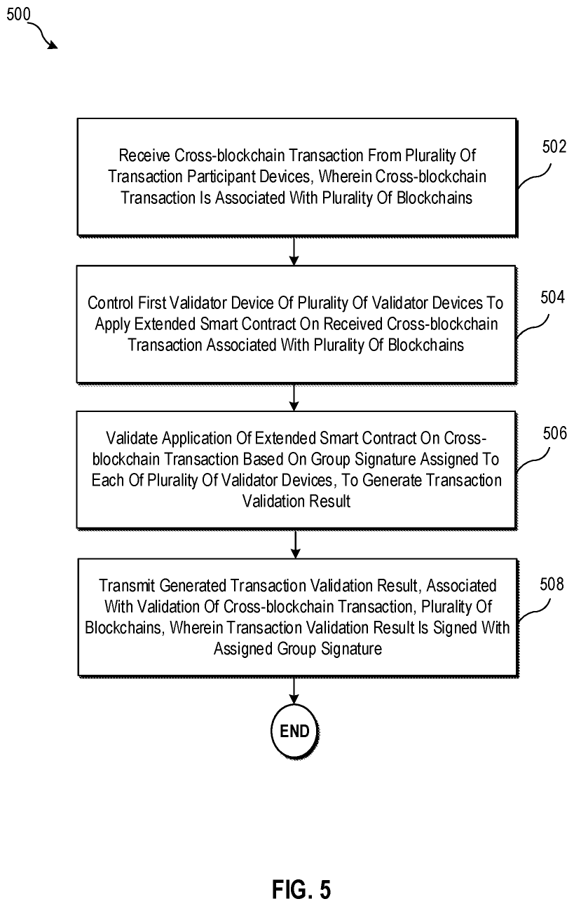

FIG. 5 illustrates a flowchart of an example method related to validation of cross-blockchain transactions by the validation system of FIG. 1, according to at least one embodiment described in the present disclosure. FIG. 5 is explained in conjunction with elements from FIG. 1, FIG. 2, FIGS. 3A-3C, and FIG. 4. With reference to FIG. 5, there is shown a flowchart 500. The method illustrated in the flowchart 500 may start at 502 and may be performed by any suitable system, apparatus, or device, such as by the example validation system 102 of FIG. 1 or the processor 202 of FIG. 2. Although illustrated with discrete blocks, the steps and operations associated with one or more of the blocks of the method may be divided into additional blocks, combined into fewer blocks, or eliminated, depending on the particular implementation.

At 502, the cross-blockchain transaction 116A-116D may be received from the plurality of transaction participant devices. In accordance with an embodiment, the processor 202 of the validation system 102 may be configured to receive the cross-blockchain transaction 116A-116D from the plurality of transaction participant devices, such as the first transaction participant device 110 and the second transaction participant device 112. In some embodiments, the cross-blockchain transaction 116A-116D may include the first transaction 116A associated with the first blockchain 106 of the plurality of blockchains and may include the second transaction 116B associated with the second blockchain 108 of the plurality of blockchains. Moreover, the first blockchain 106 may be different from the second blockchain 108. In one or more embodiments, the received first transaction 116A and the second transaction 116B of the cross-blockchain transaction 116A-116D may be signed by the plurality of transaction participant devices, such as the first transaction participant device 110 and the second transaction participant device 112 associated with the plurality of blockchains, such as the first blockchain 106 and the second blockchain 108. The receipt of the cross-blockchain transaction 116A-116D is described, for example, in FIGS. 3A-3C (at 322A and 322B).

At 504, the first validator device 104A of the plurality of validator devices 104 may be controlled. In accordance with an embodiment, the processor 202 of the validation system 102 may be configured to control the first validator device 104A of the plurality of validator devices 104 to apply the extended smart contract on the received cross-blockchain transaction 116A-116D associated with the plurality of blockchains, such as the first blockchain 106 and the second blockchain 108. The control of the first validator device 104A of the plurality of validator devices 104 is described, for example, in FIG. 3B (at 326).

At 506, the application of the extended smart contract on the cross-blockchain transaction 116A-116D may be validated. In accordance with an embodiment, the processor 202 of the validation system 102 may be configured to validate the application of the extended smart contract on the cross-blockchain transaction 116A-116D based on the group signature assigned to each of the plurality of validator devices 104. The processor 202 may be further configured to generate the transaction validation result based on the validation of the cross-blockchain transaction 116A-116D. The validation of the application of the extended smart contract on the cross-blockchain transaction 116A-116D is described, for example, in FIGS. 3A-3C (at 328, 330, and 332).

At 508, the generated transaction validation result may be transmitted. In accordance with an embodiment, the processor 202 of the validation system 102 may be configured to transmit the transaction validation result, associated with the validation of the cross-blockchain transaction 116A-116D, to the plurality of blockchains, such as the first blockchain 106 and the second blockchain 108. The transaction validation result may be signed with then assigned group signature. The transmission of the transaction validation result is described, for example, in FIGS. 3A-3C (at 336).

Control passes to end. Although the flowchart 500 is illustrated as discrete operations, such as 502, 504, 506 and 508. However, in certain embodiments, such discrete operations may be further divided into additional operations, combined into fewer operations, or eliminated, depending on the particular implementation without detracting from the essence of the disclosed embodiments.

Various embodiments of the disclosure may provide one or more non-transitory computer-readable storage media configured to store instructions that, in response to being executed, cause a validation system (such as the example validation system 102) to perform operations. The operations may include receiving a cross-blockchain transaction (such as the cross-blockchain transaction 116A-116D) from a plurality of transaction participant devices (such as the first transaction participant device 110 and the second transaction participant device 112). The cross-blockchain transaction 116A-116D may be associated with a plurality of blockchains (such as the first blockchain 106 and the second blockchain 108). The operations may further include controlling a first validator device (such as the first validator device 104A) of a plurality of validator devices (such as the plurality of validator devices 104) to apply an extended smart contract on the received cross-blockchain transaction 116A-116D associated with the plurality of blockchains. The operations may further include validating the application of the extended smart contract on the cross-blockchain transaction 116A-116D based on a group signature assigned to each of the plurality of validator devices 104, to generate a transaction validation result. The operations may further include transmitting the generated transaction validation result, associated with the validation of the cross-blockchain transaction 116A-116D, to the plurality of blockchains. The transaction validation result may be signed with the assigned group signature.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A validation system, comprising:
a plurality of validator devices, each of the plurality of validator devices is assigned with a group signature, and
a processor configured to:
receive a cross-blockchain transaction from a plurality of transaction participant devices, the cross-blockchain transaction is associated with a plurality of blockchains;
control a first validator device of the plurality of validator devices to apply an extended smart contract on the received cross-blockchain transaction associated with the plurality of blockchains;
validate the application of the extended smart contract on the cross-blockchain transaction based on the group signature assigned to each of the plurality of validator devices, to generate a transaction validation result; and
transmit the generated transaction validation result, associated with the validation of the cross-blockchain transaction, to the plurality of blockchains, the transaction validation result is signed with the assigned group signature.

2. The validation system according to claim 1, wherein the cross-blockchain transaction includes a first set of transactions associated with a first blockchain of the plurality of blockchains, and further includes a second set of transactions associated with a second blockchain of the plurality of blockchains, and wherein the first blockchain is different from the second blockchain.

3. The validation system according to claim 1, wherein the received cross-blockchain transaction is signed by the plurality of transaction participant devices associated with the plurality of blockchains.

4. The validation system according to claim 1, wherein the processor is further configured to:
register the plurality of validator devices, the plurality of blockchains, a plurality of transaction participants associated with the plurality of transaction participant devices, a set of consensus devices associated with the plurality of blockchains, and a set of security parameters;
generate the group signature for the plurality of validator devices, and
assign the generated group signature to the plurality of validator devices.

5. The validation system according to claim 4, wherein the set of security parameters are associated with a multiparty computation (MPC) scheme required for a communication between the validation system and the plurality of blockchains.

6. The validation system according to claim 1, wherein the assigned group signature includes a public key and a master secret key, wherein a threshold share of the master secret key is shared with each of the plurality of validator devices, and wherein the master secret key indicates identity information of a corresponding validator device of the plurality of validator devices.

7. The validation system according to claim 6, wherein the processor is further configured to share the public key of the group signature with each of a set of participant devices associated with the plurality of blockchains.

8. The validation system according to claim 1, wherein the processor is further configured to select the first validator device from the plurality of validator devices to apply the extended smart contract on the cross-blockchain transaction associated with the plurality of blockchains,
wherein the first validator device is selected based on a request received from the plurality of transaction participant devices, and wherein identity information of the first validator device is unknown to the plurality of transaction participant devices.

9. The validation system according to claim 1, wherein the processor is further configured to perform a first audit based on a request received from one of the plurality of validator devices, wherein the first audit is performed to verify an integrity of the first validator device for the validation performed on the cross-blockchain transaction.

10. The validation system according to claim 9, wherein the processor is configured to perform the first audit at a predefined interval.

11. The validation system according to claim 10, wherein the processor is further configured to generate identity information of the first validator device of the plurality of validator devices, based on a failure of the first audit.

12. The validation system according to claim 1, wherein the processor is further configured to perform a second audit based on a request received from a first transaction participant device of the plurality of transaction participant devices, wherein the second audit is performed to verify an integrity of the first validator device for the validation performed on the cross-blockchain transaction.

13. The validation system according to claim 12, wherein the processor is further configured to transmit identity information of the first validator device of the plurality of validator devices to the first transaction participant device, based on a failure of the second audit.

14. The validation system according to claim 13, wherein the processor is further configured to:
remove the first validator device from the plurality of validator devices based on the failure of the second audit; and
re-configure the validation system with other validator devices of the plurality of validator devices, wherein the other validator devices are different from the first validator device.

15. A method, comprising:
in a validation system comprising a plurality of validator devices, each of the plurality of validator devices is assigned with a group signature:
receiving a cross-blockchain transaction from a plurality of transaction participant devices, the cross-blockchain transaction is associated with a plurality of blockchains;
controlling a first validator device of the plurality of validator devices to apply an extended smart contract on the received cross-blockchain transaction associated with the plurality of blockchains;
validating the application of the extended smart contract on the cross-blockchain transaction based on the group signature assigned to each of the plurality of validator devices, to generate a transaction validation result; and
transmitting the generated transaction validation result, associated with the validation of the cross-blockchain transaction, to the plurality of blockchains, the transaction validation result is signed with the assigned group signature.

16. The method according to claim 15, further comprising:
registering the plurality of validator devices, the plurality of blockchains, a plurality of transaction participants associated with the plurality of transaction participant devices, a set of consensus devices associated with the plurality of blockchains, and a set of security parameters;
generating the group signature for the plurality of validator devices, and
assigning the generated group signature to the plurality of validator devices.

17. The method according to claim 15, further comprising performing a first audit based on a request received from one of the plurality of validator devices, wherein the first audit is performed to verify an integrity of the first validator device for the validation performed on the cross-blockchain transaction.

18. The method according to claim 15, further comprising performing a second audit based on a request received from a first transaction participant device of the plurality of transaction participant devices, wherein the second audit is performed to verify an integrity of the first validator device for the validation performed on the cross-blockchain transaction.

19. The method according to claim 18, further comprising transmitting identity information of the first validator device of the plurality of validator devices to the first transaction participant device, based on a failure of the second audit.

20. One or more non-transitory computer-readable storage media configured to store instructions that, in response to being executed, cause a validation system to perform operations, the operations comprising:
receiving a cross-blockchain transaction from a plurality of transaction participant devices, the cross-blockchain transaction is associated with a plurality of blockchains;
controlling a first validator device of a plurality of validator devices to apply an extended smart contract on the received cross-blockchain transaction associated with the plurality of blockchains;
validating the application of the extended smart contract on the cross-blockchain transaction based on a group signature assigned to each of the plurality of validator devices, to generate a transaction validation result; and
transmitting the generated transaction validation result, associated with the validation of the cross-blockchain transaction, to the plurality of blockchains, the transaction validation result is signed with the assigned group signature.
